(19) United States
(12) Patent Application Publication
(10) Pub. No.: US 2026/0139144 A1
(43) Pub. Date: May 21, 2026

(54) INKJET INK AND IMAGE FORMING METHOD

(71) Applicant: Konica Minolta, Inc., Tokyo (JP)

(72) Inventor: Ken NITO, Tokyo (JP)

(21) Appl. No.: 19/360,226

(22) Filed: Oct. 16, 2025

(30) Foreign Application Priority Data
Nov. 19, 2024 (JP) 2024-201472

(51) Int. Cl. C09D 11/30; B41J 3/407; C09D 11/102; D06P 1/52; D06P 5/30

(52) U.S. Cl. CPC C09D 11/30; C09D 11/102; D06P 1/5285; D06P 5/30; B41J 3/4078

(57) ABSTRACT

The inkjet ink includes water, a water-dispersible resin, and a blocked isocyanate compound. The blocked isocyanate compound includes three or more blocked isocyanate groups in which an isocyanate group is blocked with dimethylpyrazole. In one embodiment, the blocked isocyanate compound does not have a cyclic structure. In one embodiment, the blocked isocyanate compound is a compound in which isocyanate groups of hexamethylene diisocyanate biuret is blocked.

### CROSS REFERENCE TO RELATED APPLICATIONS

The entire disclosure of Japanese Patent Application No. 2024-201472 filed on Nov. 19, 2024, is incorporated herein by reference in its entirety.

### BACKGROUND

### Technological Field

The present invention relates to an inkjet ink and an image forming method.

### Description of Related Art

As image formation, in recent years, inkjet recording has been widely performed in which an image is formed on a base material by an inkjet method because dyeing can be performed in a short time and production efficiency is high.

As inkjet ink (hereinafter, also referred to simply as “ink”) used in inkjet recording, dye ink has been mainly used, but the use of pigment ink, which can omit post-treatment such as a washing step of washing away dye that has not been dissolved or reacted, has been studied.

While the pigment ink exhibits high color developability by causing the pigment particles to remain on the surface of the base material, the pigment ink tends to have lower pigment particle fixability and poorer friction fastness than the dye ink. Therefore, from the viewpoint of improving the fastness of an image and the like, adding a crosslinking agent to an ink has been studied (e.g., Japanese Unexamined Patent Publication No. 2019-31611, Japanese Unexamined Patent Publication No. 2023-66349, and Japanese Unexamined Patent Publication No. 2014-129617).

However, according to the findings of the present inventors, when the inks described in these patent literatures are stored over time, images formed using the inks that have been stored over time are unsatisfactory in terms of friction fastness.

### SUMMARY

The present invention has been made in view of the above-described problems, and an object of the present invention is to provide an inkjet ink and an image forming method capable of improving the friction fastness even when the ink is stored over time.

In order to achieve at least one of the above-mentioned objects, an inkjet ink reflecting one aspect of the present invention includes water, a water-dispersible resin, and a blocked isocyanate compound, and the blocked isocyanate compound includes three or more blocked isocyanate groups in which an isocyanate group is blocked with dimethylpyrazole.

### DETAILED DESCRIPTION OF EMBODIMENTS

The advantageous and features provided by one or more embodiments of the invention will become more fully understood from the detailed description given hereinbelow, and thus are not intended as a definition of the limits of the present invention.

In the following, one or more embodiments of the present invention will be described. However, the scope of the invention is not limited to the disclosed embodiments.

Hereinafter, an embodiment of the present invention will be described in detail. Note that the present invention is not limited to the following forms.

Note that in the present specification, a numerical range indicated by using “to” means a range including numerical values described before and after “to” as a lower limit value and an upper limit value.

In addition, in the present specification, “(meth)acrylate” means one or both of acrylate and methacrylate, and “(meth)acryl” means one or both of acryl and methacryl.

### 1. Inkjet Ink

The inkjet ink (hereinafter, also simply referred to as “ink”) according to the present embodiment contains water, a water-dispersible resin, and a blocked isocyanate compound.

### 1-1. Blocked Isocyanate Compound

The blocked isocyanate compound is a compound containing a blocked isocyanate group. A blocked isocyanate group is a functional group which becomes an isocyanate group by elimination of a blocking agent by heat. Then, the isocyanate group and the hydroxy moiety of the water-dispersible resin and/or the hydroxy moiety of the base material form a crosslinking bond, and the wet friction fastness of the image can be improved. The hydroxy moiety may be an OH moiety of a hydroxy group, or may be an OH moiety contained in a carboxy group, a phosphonic acid group, a sulfonic acid group, or the like.

The blocked isocyanate compound according to the present embodiment is not particularly limited as long as it is a compound including three or more blocked isocyanate groups in which the isocyanate groups are blocked with dimethylpyrazole. The dimethylpyrazole used as the blocking agent is preferably dimethylpyrazole which has two methyl groups on ring carbons, and more preferably 3,5-dimethylpyrazole.

The reaction in which dimethylpyrazole is eliminated from the blocked isocyanate group is an equilibrium reaction, and dimethylpyrazole has a relatively high boiling point. Therefore, even when some dimethylpyrazole is eliminated during storage of the ink over time, it is less likely to volatilize from the ink, making it easier to maintain the equilibrium reaction and facilitate reblocking of the isocyanate group. As a result, deactivation of the isocyanate group by water is less likely to proceed, and even when the ink is stored over time, the wet friction fastness of the obtained image is more likely to increase.

In addition, when the number of the blocked isocyanate groups is three or more, a dense crosslinked structure is easily formed. Furthermore, when the ink has been stored with time and some of the isocyanate groups have been deactivated by water or the like, for example, in the case of a compound having two blocked isocyanate groups, the compound in which even one isocyanate group has been deactivated cannot contribute to the formation of a crosslinked structure. On the other hand, when the ink has three or more blocked isocyanate groups, two blocked isocyanate groups can remain and can contribute to a crosslinked structure even when some of the functional group are deactivated. Therefore, it is thought that even when the ink is stored over time, a sufficient crosslinked structure can be formed, and the wet friction fastness is more likely to increase.

Furthermore, during image formation, the water-based solvent is dried to some extent, and the blocking agent is volatilized while the ink loses fluidity in some cases. In such a case, pinholes are formed in the image, and the fastness of the image is reduced. On the other hand, dimethylpyrazole has a relatively high boiling point as described above, and therefore, volatilization of the blocking agent during image formation is also more likely to be suppressed, thus pinholes are less likely to be formed in the image, and therefore, the wet friction fastness is more likely to increase.

The number of blocked isocyanate groups in the blocked isocyanate compound is three or more, preferably three to five, and more preferably three. When the number is 3 or more, even when the ink is stored over time as described above, a sufficient crosslinked structure can be formed, and the wet friction fastness is easily improved. When the number is 5 or less, the crosslinked structure can be controlled so as not to be too dense, and thus the obtained image is less likely to become fragile, and in particular, when a fabric is used as the base material, the texture is more likely to be improved.

As the isocyanate compound used in the blocked isocyanate compound, a known tri- or higher-functional isocyanate compound can be used. The isocyanate compound may be a tri- or higher functional isocyanate compound obtained by polymerizing a diisocyanate compound. Among them, a trifunctional isocyanate compound in which a diisocyanate compound is trimerized to form a biuret structure or a trifunctional isocyanate compound in which a diisocyanate compound is trimerized to have an isocyanurate structure is preferably used.

The diisocyanate compound used for obtaining the isocyanate compound having tri- or higher-functional groups by polymerization is not particularly limited, and examples thereof include hexamethylene diisocyanate, tolylene diisocyanate, lysine diisocyanate, isophorone diisocyanate, hydrogenated xylylene diisocyanate, xylene diisocyanate, and diphenylmethane diisocyanate. Among these, hexamethylene diisocyanate and isophorone diisocyanate are preferable, and hexamethylene diisocyanate is more preferably used from the viewpoint of having an appropriately flexible linking chain, making it difficult for the obtained image to become fragile, and making it easy to increase the texture particularly in the case of using a fabric as the base material.

The isocyanate compound may have a cyclic structure or does not have to have a cyclic structure, but the number of cyclic structures included in the isocyanate compound is preferably 0 to 4, more preferably 0 to 1, and even more preferably 0. When the isocyanate compound has a cyclic structure, the movement of the molecular chain is restricted to some extent, and therefore when a crosslinked structure is formed, the resulting image tends to become hard and brittle. On the other hand, the fewer cyclic structures contained in the isocyanate compound, the more flexible the resulting image will be when a crosslinked structure is formed, and the less likely it will be brittle, which will tend to improve the texture, particularly when fabric is used as the base material.

The isocyanate compound used in the blocked isocyanate compound is preferably a trifunctional isocyanate compound in which a diisocyanate compound is trimerized to form a biuret structure, from the viewpoint that the isocyanate compound does not has a cyclic structure and the texture is easily improved when a fabric is used as the base material. Furthermore, from the viewpoint that the texture is more easily improved, a trifunctional isocyanate compound in which hexamethylene diisocyanate is trimerized to form a biuret structure (hexamethylene diisocyanate biuret) is more preferable.

The lower limit value of the content of the blocked isocyanate compound is preferably 0.01% by mass or more with respect to the total mass of the ink, more preferably 0.04% by mass or more, even more preferably 0.10% by mass or more, even more preferably 0.40% by mass or more, and most preferably 0.75% by mass or more. By increasing the amount of the blocked isocyanate compound, the wet friction fastness is easily improved.

On the other hand, the upper limit of the content of the blocked isocyanate compound is preferably 5.00% by mass or less, more preferably 2.50% by mass or less, still more preferably 1.75% by mass or less, yet more preferably 1.25% by mass or less, and most preferably 1.00% by mass or less, with respect to the total mass of the ink. When the addition amount of the blocked isocyanate compound is further decreased, the obtained image is less likely to become fragile, and in particular, when a fabric is used as the base material, the texture is more likely to be improved.

Among these, from the viewpoint of easily improving the wet friction fastness, the content is preferably from 0.40% by mass to 5.00% by mass, more preferably from 0.75% by mass to 5.00% by mass, and even more preferably from 0.75% by mass to 2.50% by mass. In addition, from the viewpoint of making an image less likely to become fragile, and particularly when the base material is a fabric, to improving the texture, the content is preferably 0.01% by mass to 1.75% by mass, more preferably 0.01% by mass to 1.25% by mass, and even more preferably 0.04% by mass to 1.25% by mass. Furthermore, from the viewpoint of increasing wet friction fastness and making an image less likely to become fragile, the content is preferably from 0.01% by mass to 5.00% by mass, more preferably from 0.04% by mass to 2.50% by mass, even more preferably from 0.10% by mass to 1.75% by mass, even more preferably from 0.10% by mass to 1.25% by mass, even more preferably from 0.10% by mass to 1.00% by mass, even more preferably from 0.40% by mass to 1.00% by mass, and most preferably from 0.75% by mass to 1.00% by mass.

### 1-2. Water-Dispersible Resin

The water-dispersible resin facilitates fixing of the pigment or the like to the base material. The water-dispersible resin may be contained in the ink as resin particles. The water-dispersible resin may be either self-emulsifying resin particles into which a hydrophilic group has been introduced, or forcibly emulsifying resin particles that become water-dispersible by the use of an external emulsifier. From the viewpoint of suppressing bleed-out, a self-emulsifying type is preferable.

The glass transition temperature (Tg) of the water-dispersible resin is preferably low from the viewpoint that the image is less likely to become fragile and that the texture is more likely to be maintained when a fabric is used as the base material. The Tg of the water-dispersible resin is preferably −80° C. to 50° C., and more preferably −70° C. to 10° C. The Tg of the water-dispersible resin can be measured at a heating rate of 10° C./min in accordance with JIS K7121: 2012.

The water-dispersible resin may have a cationic group or an anionic group. For example, since the pre-treatment liquid preferably contains a resin having a cationic group (hereinafter, also referred to as a “cationic resin”), the water-dispersible resin in the ink preferably contains a resin having an anionic group (hereinafter, also referred to as an “anionic resin”). Examples of the anionic group include a carboxy group, a sulfonic acid group and a phosphonic acid group.

Examples of the water-dispersible resin include (meth)acrylic resins, styrene resins, urethane resins, and ester resins each having an anionic group. Among these, from the viewpoint that the Tg of the resin is moderately low and the viewpoint of flexibility, a (meth)acrylic resin having an anionic group or a urethane resin having an anionic group is preferable, and a urethane resin having an anionic group is more preferable.

### ((Meth)Acrylic Resin Having Anionic Group)

The (meth)acrylic resin having an anionic group is a polymer of a (meth)acrylic monomer, or a copolymer with another monomer copolymerizable with the (meth)acrylic monomer. At least one of the (meth)acrylic monomer and the other monomer, preferably the (meth)acrylic monomer, has an anionic group. The (meth)acrylic monomer is a monomer having a (meth)acryloyl group. The term (meth)acryl is a concept including both methacryl and acryl.

Examples of the (meth)acrylic monomer having an anionic group include acrylic acid and methacrylic acid. Examples of the other (meth)acrylic monomer include (meth)acrylic acid esters such as methyl (meth)acrylate, ethyl (meth)acrylate, and hydroxyethyl (meth)acrylate; (meth)acrylamides; and (meth)acrylic monomers having no anionic group such as (meth)acrylonitrile.

Examples of the other copolymerizable monomer include monofunctional monomers such as ethylenically unsaturated carboxylic acids (e.g., maleic acid and itaconic acid), styrene compounds (e.g., styrene, α-methylstyrene and vinyl toluene), saturated fatty acid vinyl compounds (e.g., vinyl acetate and vinyl propionate), vinyl compounds (e.g., 1,4-divinyloxybutane and divinylbenzene), allyl compounds (e.g., diallyl phthalate and triallyl cyanurate), and difunctional or higher functional monomers such as polyfunctional (meth)acrylates (e.g., diethylene glycol di(meth)acrylate, 1,6-hexanediol di(meth)acrylate, propylene glycol di(meth)acrylate and N,N′-methylenebis(acrylamide)) and polyfunctional acrylamide.

Among these, from the viewpoint of lowering the Tg of the water-dispersible resin, the (meth)acrylic monomer preferably contains acrylic acid or an alkyl acrylate. The alkyl acrylate is preferably a C4-12 alkyl acrylate, more preferably n-butyl acrylate or 2-ethylhexyl acrylate.

### (Urethane Resin Having Anionic Group)

Examples of the urethane resin having an anionic group include an ether-based urethane resin, an ester-based urethane resin, and a carbonate-based urethane resin. Among these urethane resins, an ether-based urethane resin is preferable from the viewpoint of having a flexible alkylene oxide skeleton, making an image to be obtained to become less fragile, and making it easy to improve the texture in a case where the base material is a fabric. The urethane resin having an anionic group is preferably of a self-emulsifying type. The self-emulsifying urethane resin may be, for example, a polyaddition reaction product of a polyhydric alcohol having an anionic group and a polyhydric isocyanate.

Examples of commercially available products of the urethane resin include TAKELAC (R) W-6010 (polycarbonate-based/anion-type), TAKELAC (R) W-6110 (polycarbonate-based/anion-type), TAKELAC (R) W-6020 (ether-based/anion-type), TAKELAC (R) W-6061 (ether-based/anion-type), TAKELAC (R) W-405 (ester-based/anion-type), TAKELAC (R) W-605 (ester-based/anion-type), TAKELAC (R) WS-5000 (polyester-based/anion-type), and TAKELAC (R) WS-4000 (polycarbonate-based/anion-type) (all manufactured by Mitsui Chemicals, Inc), SUPERFLEX (R) 126 (ether/ester-based, anion-type), SUPERFLEX (R) 130 (ether-based, anion-type), SUPERFLEX (R) 150 (ether/ester-based, anion-type), SUPERFLEX (R) 300 (ether/ester-based, weak anion-type), SUPERFLEX (R) 420 (polycarbonate-based/anion-type), and SUPERFLEX (R) 460 (polycarbonate-based/anion-type) (all manufactured by DKS Co., Ltd.).

### (General Matters)

The average particle size of the water-dispersible resin is preferably from 80 nm to 400 nm, more preferably from 150 nm to 300 nm. The average particle size of the water-dispersible resin can be measured by the same method as the average particle size of the pigment particle.

The content of the water-dispersible resin in the ink is preferably 1.0% by mass to 20.00% by mass, more preferably 5.0% by mass to 15.0% by mass, with respect to the total mass of the ink. When the content of the water-dispersible resin is equal to or more than the lower limit value, the fixability of the ink to a base material is more easily improved. When the content of the water-dispersible resin is equal to or lower than the upper limit value, the base material does not become excessively hard, and in a case where a fabric is used as the base material, the texture can be further prevented from being impaired. The water-dispersible resin may be one type or two or more types.

### 1-3. Pigment

The ink according to the present embodiment may or may not contain a pigment, but preferably contains a pigment. When the blocked isocyanate compound forms a crosslinked structure, the pigment is incorporated into the crosslinked structure, and thus the wet friction fastness is easily improved.

As the pigment, a known pigment can be used, and for example, organic pigments or inorganic pigments having the following numbers described in the Color Index can be used.

Examples of orange pigments include C.I. Pigment Orange 31, 43, and 47.

Examples of the red or magenta pigment include the following:
Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 202, 208, 216, 226, 254, 257, Pigment Violet 3, 19, 23, 29, 30, 37, 50, 88, and Pigment Orange 13, 16, 20, 36.

Examples of the blue or cyan pigment include the following:
Pigment Blue 1, 15, 15:1, 15:2, 15:3, 15:4, 15:6, 16, 17-1, 22, 27, 28, 29, 36, and 60.

Examples of green or yellow pigments include Pigment Green 7, 26, 36, and 50.

Examples of yellow pigments include the following:
Pigment Yellow 1, 3, 12, 13, 14, 15, 17, 34, 35, 37, 55, 74, 81, 83, 93, 94, 95, 97, 108, 109, 110, 128, 137, 138, 139, 151, 153, 154, 155, 157, 166, 167, 168, 180, 185, 193, and 213.

Examples of black pigments include Pigment Black 7, 28, and 26.

Examples of the white pigment include titanium dioxide.

The pigment is preferably further dispersed with a pigment-dispersing agent from the viewpoint of improving the dispersibility in the ink. The pigment-dispersing agent will be described below.

The pigment may be a self-dispersible pigment. The self-dispersible pigment is obtained by modifying the surface of a pigment particle with a group having a hydrophilic group, and has a pigment particle and a group having hydrophilicity bonded to the surface of the pigment particle.

Examples of the hydrophilic group include a carboxy group, a sulfonic acid group, and a phosphorus-containing group. Examples of the phosphorus-containing group include a phosphate group, a phosphonic acid group, a phosphinic acid group, a phosphite group, and a phosphate group.

Commercial examples of self-dispersible pigments include Cab-0-Jet (registered trademark) 200K, 250C, 260M, and 270 V (self-dispersible pigment containing sulfonic acid group), Cab-0-Jet (registered trademark) 300K (carboxylic acid group-containing self-dispersible pigments), Cab-0-Jet (registered trademark) 400K, 450C, 465M, 470V, and 480V (phosphate group-containing self-dispersible pigments) from Cabot Corporation.

The content of the pigment is not particularly limited, but is preferably from 0.3% by mass to 10.0% by mass, and more preferably from 0.5% by mass to 5.0% by mass, with respect to the ink, from the viewpoints of facilitating adjustment of the viscosity of the ink to fall within the aforementioned range and enabling formation of a high-density image. When the content of the pigment is equal to or greater than the lower limit value, the color of an image is more likely to become vivid. When the content of the pigment is equal to or less than the upper limit value, the viscosity of the ink does not become excessively high, and the ejection stability is not easily impaired.

### 1-4. Aqueous Solvent

The inkjet ink according to the present embodiment contains at least water, and contains preferably a water-based solvent further containing a water-soluble organic solvent.

The water-soluble organic solvent is not particularly limited as long as it is compatible with water, and examples thereof include polyhydric alcohols (e.g., dihydric alcohols such as ethylene glycol, diethylene glycol, triethylene glycol, polyethylene glycol, propylene glycol, dipropylene glycol, tripropylene glycol and polypropylene glycol, and trihydric or higher alcohols such as glycerol, trimethylolpropane and hexanetriol); polyhydric alcohol ethers (e.g., ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, diethylene glycol dimethyl ether, propylene glycol monomethyl ether and propylene glycol monoethyl ether); monohydric alcohols (e.g., methanol, ethanol, propanol, pentanol, hexanol, cyclohexanol and benzyl alcohol); amines (e.g., ethanolamine, N-ethyldiethanolamine, morpholine, N-ethylmorpholine, ethylenediamine, diethylenediamine and triethylenetetramine); amides (e.g., formamide, N,N-dimethylformamide and N,N-dimethylacetamide); heterocycles (e.g., 2-pyrrolidone, N-methyl-2-pyrrolidone, N-cyclohexyl-2-pyrrolidone, 2-oxazolidone and 1,3-dimethyl-2-imidazolidine); sulfoxides (e.g., dimethyl sulfoxide); and sulfones (e.g., sulfolane).

Furthermore, from the viewpoint of further improving ejection stability by inkjet, a high-boiling-point solvent having a boiling point of 180° C. or higher is preferably included. The boiling point of the high-boiling-point solvent is preferably 190° C. or higher, more preferably 200° C. or higher. Examples of solvents having a boiling point of 200° C. or higher include dihydric alcohols such as 1,3-butanediol (boiling point: 208° C.), 1,6-hexanediol (boiling point: 223° C.) and polypropylene glycol; and trihydric or higher alcohols such as glycerin (boiling point: 290° C.) and trimethylolpropane (boiling point: 295° C.).

The content of water is preferably 30.0% by mass to 85.0% by mass and more preferably 40.0% by mass to 75.0% by mass with respect to the total mass of the ink. The total mass of the water-soluble organic solvent is preferably 10.0% by mass to 70.0% by mass, more preferably 20.0% by mass to 60.0% by mass, with respect to the total mass of the ink.

### 1-5. Other Components

The ink may further contain other components, if necessary. Examples of the other components include a pigment-dispersing agent, a surfactant, a preservative, a fungicide, and a pH adjuster.

### (Surfactant)

The surfactant may lower the surface tension of the inkjet composition to improve wetting to the base material. The type of surfactant is not particularly limited, and may be, for example, an acetylene glycol-based surfactant, a silicone-based surfactant, or a fluorine-based surfactant. Examples of commercially available products of surfactant include OlfinE1010 (manufacturedby Nissin Chemical Industry Co., Ltd), TEGOWET250 (manufacturedby Evonik), and the like.

### (Preservative or Fungicide)

Examples of the preservative or fungicide include aromatic halogen compounds (for example, Preventol CMK), methylene dithiocyanate, a halogen-containing nitrogen-sulfur compound, and 1,2-benzisothiazolin-3-one. An example of the preservative or the fungicide is ProxelGXL (S) (manufactured by Lonza).

### (Pigment-Dispersing Agent)

The pigment-dispersing agent is present in the ink in such a manner as to surround the surfaces of pigment particles or is adsorbed onto the surfaces of pigment particles to form a pigment dispersion liquid and thereby satisfactorily disperse the pigment. The pigment-dispersing agent is preferably a polymer dispersant, more preferably an anionic polymer dispersant.

The anionic polymer dispersant is a polymer dispersant having a hydrophilic group such as a carboxy group, a phosphate group and a sulfonic acid group, and preferably a polymer dispersant having a carboxy group.

The polymer dispersant having a carboxy group may include a constitutional unit derived from an unsaturated carboxylic acid monomer or a constitutional unit derived from a salt of an unsaturated carboxylic acid monomer. Examples of the unsaturated carboxylic acid monomer include acrylic acid or a derivative thereof, maleic acid or a derivative thereof, itaconic acid or a derivative thereof, and fumaric acid or a derivative thereof. The anionic polymer dispersant may be a copolymer having a constitutional unit derived from the unsaturated carboxylic acid monomer or a constitutional unit derived from a salt of the unsaturated carboxylic acid monomer, and a constitutional unit derived from another monomer. Examples of other monomers include styrene, butyl acrylate, and vinyl naphthalene.

The polymer dispersing agent preferably has an anionic group equivalent weight of, for example, 1.1 meq/g to 3.8 meq/g from the viewpoint of sufficiently dispersing the pigment particles. When the anionic group equivalent weight is within the above range, high pigment dispersibility is easily obtained without increasing the molecular weight of the anionic polymer dispersant. The anionic group equivalent weight of the anionic polymer dispersant can be determined from the acid value. The acid number can be measured in accordance with JIS K 0070: 1992.

The weight-average molecular weight (Mw) of the polymer dispersant is not particularly limited, but is preferably 5000 to 30000. When the Mw of the polymer dispersant is 5000 or more, the pigment particle are easily and sufficiently dispersed, and when the Mw is 30000 or less, the ink does not become excessively viscous, and therefore, the permeability into the base material is less likely to be impaired. The Mw of the polymer dispersant can be measured by the same method as described above. The weight-average molecular weight (Mw) of the polymer dispersant can be measured by gel permeation chromatography in terms of polystyrene.

The content of the polymer dispersant is not particularly limited as long as the polymer dispersant sufficiently disperses pigment particle and has a viscosity to the extent that the permeability into a base material is not impaired. The content of the polymer dispersant is preferably from 20% by mass to 100% by mass, more preferably from 25% by mass to 60% by mass, with respect to the content mass of the pigment.

### 1-6. Physical Properties

The viscosity of the ink at 25° C. is not particularly limited as long as the ejection property by an inkjet method are satisfactory, but is preferably 3 mPa-s to 20 mPa-s, and more preferably 4 mPa-s to 12 mPa-s. The viscosity of the ink can be measured at 25° C. using an E-type viscometer.

### 2. Image Forming Method

Δn image forming method according to an embodiment of the present invention may include at least a step 1) of applying the above-described ink onto a base material by an inkjet method.

In a case where the above-described ink contains a pigment, a step 2) of applying a treatment liquid to the base material may be included. Step 2) may be performed before step 1) by using a post-treatment liquid as the treatment liquid, or may be performed after step 1) by using a pre-treatment liquid as the treatment liquid. Step 2) may be performed before or after step 1) by using a pre-treatment liquid and a post-treatment liquid.

Furthermore, in a case where the above-described ink is a clear ink that does not contain a pigment, the above-described ink may be used as the treatment liquid, and a step of applying an inkjet ink containing a pigment may be included separately from step 1).

### 2-1. Step 1) of Applying Ink

The ink according to the present embodiment is applied onto a base material by an inkjet method.

The type of the base material is not particularly limited, but for example, may be a paper base material having high water-absorbing properties, may be a non-water-absorbing base material such as a film or a plastic board (soft vinyl chloride, hard vinyl chloride, an acrylic plate, a polyolefin-based board, or the like), or may be a fabric. Among these, for example, in the case of abase material containing a material having a hydroxyl group such as cellulose, the blocked isocyanate compound and the base material can form a crosslinked structure, thereby easily improving wet friction fastness.

Examples of the fabric include natural fibers such as cotton (cellulose fibers), hemp, wool, and silk; chemical fibers such as rayon, vinylon, nylon, acrylic, polyurethane, polyester, and acetate; and blended fibers thereof. Of these, the resin constituting the fabric may be hydrophilic fibers such as cotton, hydrophobic fibers such as polyester, or blended fibers thereof. In addition, the fabric may be any form of these fibers, such as a woven fabric, a nonwoven fabric, and a knitted fabric. Furthermore, the fabric may be a blended woven fabric or a blended nonwoven fabric of two or more types of fibers.

When the ink contains a pigment, a aggregating agent for aggregating the pigment or the like may be attached to the base material. That is, a base material including a base material and an aggregating agent attached thereto may be used. In this manner, the pigment and the water-dispersible resin in the ink can be more likely to aggregate on the base material.

In addition, in a case where the ink does not include a pigment, a pigment may be attached to the base material, that is, a base material including the base material and a pigment attached thereto may be used.

Next, the ink applied onto the base material may be further dried, or in a case of applying a post-treatment liquid, the post-treatment liquid may be applied by a wet-on-wet method after the ink application, and the drying may be collectively performed after the post-treatment liquid application.

The ink is dried by removing the water-based solvent and the like contained in each liquid applied to the base material. The drying method is not particularly limited, and the drying may be performed at room temperature or may be performed by heating. The heating method may be a method using a heater, a hot air dryer, a heating roller, or the like, and is preferably a method of heating from both surfaces of the base material using a hot air dryer and a heater.

The drying temperature is not particularly limited, but can be, for example, 80° C. to 180° C. The drying temperature is preferably 110° C. to 170° C. or lower. When the temperature is 110° C. or higher, the blocking agent is easily eliminated, and thus the crosslinking reaction easily proceeds efficiently. When the temperature is 170° C. or less, deterioration such as fabric burning and shrinkage of the base material is easily reduced. The drying time may be, for example, 1 minute to 10 minutes, depending on the drying temperature.

### 2-2. Step 2) Step of Applying Treatment Liquid

### 2-2-1. Step of Applying Pre-Treatment Liquid

In the step of applying the pre-treatment liquid, for example, the base material is brought into contact with the pre-treatment liquid containing the aggregating agent and then dried, so that the base material to which the aggregating agent adheres can be obtained.

### (Pre-Treatment Liquid)

The pre-treatment liquid includes at least an aggregating agent and an aqueous solvent.

The type of the aggregating agent may be any agent as long as the pigment or the like contained in the ink is aggregated, and may be an agent that utilizes a change in pH or an agent that utilizes an electrical action.

Examples of the aggregating agent that causes aggregation by a change in pH include organic acids. Examples of the organic acid include carboxylic acids having 6 or less carbon atoms, such as saturated fatty acids (e.g., formic acid, acetic acid, propionic acid, butyric acid, valeric acid, and hexanoic acid) and hydroxy acids (e.g., lactic acid, malic acid, and citric acid).

The aggregating agent that causes aggregation by an electrical action includes polyvalent metal salts and compounds having a cationic group or an anionic group. For example, when the pigment-dispersing agent contained in the ink is anionic, the aggregating agent preferably contains a polyvalent metal salt or a compound having a cationic group.

The polyvalent metal salt may be a water-soluble compound having a divalent or more polyvalent metal ion and an anion to be bonded thereto. Examples of the polyvalent metal ion include divalent metal ions such as Ca²⁺, Cu²⁺, Ni²⁺, Mg²⁺, Zn²⁺, and Ba²⁺; and trivalent metal ions such as Al³⁺, Fe³⁺, and Cr³⁺. Examples of the anion include Cl⁻, I⁻, Br, SO₄²⁻, ClO₃⁻, NO₃⁻ and HCOO⁻, CH₃COO⁻. Among these, calcium salts and magnesium salts are preferable, and calcium nitrate and calcium chloride are more preferable.

Examples of the cationic group in the compound having a cationic group include a secondary amino group, a tertiary amino group, and a quaternary ammonium salt group. Examples of the compound having a cationic group include the cationic urethane compounds described above. In addition, cationic resins such as cationic urethane resin, cationic olefin resin, and cationic allylamine resin; and quaternary salts of alkylamine-epichlorohydrin adducts may also be used.

As the aqueous solvent, the same solvents as those exemplified for the ink can be used. The pre-treatment liquid may further contain, if necessary, a known pH adjuster, preservative, and the like.

As a method of bringing a base material into contact with the pre-treatment liquid, the same method as the method of applying the ink can be used. The adhesion amount of the aggregating agent is not particularly limited, and may be, for example, 0.1 g/m² to 5.0 g/m².

### 2-2-2. Step of Applying Post-Processing Liquid

In the step of applying the post-treatment liquid, the post-treatment liquid is applied onto the ink applied to the base material. As a result, the fixability of the pigment can be easily improved, and the surface slipperiness can be easily improved.

The method of applying the post-treatment liquid is not particularly limited and may be any of a dipping method, a spraying method, and an inkjet method, but is preferably an inkjet method.

In order to reduce the viscosity of the post-treatment liquid, to more stably perform ejection by inkjet, and to suppress fluctuation of the ejection temperature due to temperature fluctuation of the inkjet head, the post-treatment liquid is preferably applied after temperature adjustment. Specifically, the heating temperature of the post-treatment liquid is preferably 20° C. to 35° C., and more preferably 30° C. to 35° C.

After the post-treatment liquid is applied, the inkjet composition applied onto the base material may be further dried. The method and conditions for drying the post-treatment liquid may be the same as the method and conditions for drying the ink.

### (Post-Treatment Liquid)

The post-treatment liquid contains a resin and an aqueous solvent.

The type of the resin may be the same as the “water-dispersible resin” used in the ink, may be a known overcoat material, or when the method includes a step of applying the pre-treatment liquid, the resin may be a resin that interacts with the aggregating agent contained in the pre-treatment liquid. In addition, the type of the resin is not particularly limited as long as the fixability of the pigment or the like are improved.

Examples of the overcoat material include materials containing anionic resin fine particles. The anionic resin fine particles have a glass transition temperature Tg of preferably 50° C. or higher, and more preferably 100° C. or higher, from the viewpoint of suppressing stickiness of an image and deterioration of texture of a base material on which an image is formed. The glass transition temperature Tg of the anionic polymer fine particles can be measured by differential scanning calorimetry at a heating rate of 10° C./min in accordance with JIS K 7121: 2012.

Examples of the anionic resin fine particles include fine particles of a polymer having a functional group capable of carrying a negative charge. Examples of such a functional group include a carboxyl group, a hydroxyl group, and a sulfate group.

Examples of commercially available products containing anionic polymer fine particles include AQUACER507 manufactured by BYK and Hitec E-4A manufactured by Toho Chemical Industry Co., Ltd.

In addition, in a case where the resin contained in the post-treatment liquid interacts with the aggregating agent contained in the pre-treatment liquid and the pre-treatment liquid contains a cationic aggregating agent, the post-treatment liquid preferably contains an anionic aggregating agent. By adopting such a mode, electrostatic repulsion between the aggregating agents contained in the pre-treatment liquid is suppressed, the aggregation property of the pigment and the like is improved, and the fastness of the image-formed product is more likely to be improved. In this case, the same anionic resins as those exemplified as the water-dispersible resin of the ink can be used.

The application amount of the inkjet composition can be set such that the adhesion amount of the resin is preferably 0.3 g/m² to 3.0 g/m², and more preferably 0.3 g/m² to 1.5 g/m². When the adhesion amount of the resin is within the above range, the image is less likely to become fragile, and the texture can be further improved when a fabric is used as the base material.

### EXAMPLE

Hereinafter, the present invention will be specifically described with reference to examples, but the present invention is not limited thereto.

### 1. Preparation of Pre-Treatment Solution

The following components were mixed so that the total amount was 100.00 parts by mass to prepare a pre-treatment liquid.

Composition of pre-treatment liquid

| | |
|---|---|
| Quaternary salts of an adduct of | 2.00 parts by mass |
| alkylamine and epichlorohydrin: | |
| Glycerin: | 10.00 parts by mass |
| Propylene glycol: | 20.00 parts by mass |
| ProxelGXL (S) (preservative, manufactured | 0.05 parts by mass |
| by Lonza): | |
| Surfynol E1010 (surfactant, manufactured | 0.10 parts by mass |
| by Nissin Chemical Industry Co., Ltd.): | |
| Ion-exchanged water: | balance |

### 2. Preparation of Ink

### 2-1. Preparation of Pigment Dispersion Liquid

After mixing 63 parts by mass of water with 7 parts by mass of a styrene-butyl acrylate-methacrylic acid copolymer (anionic dispersing agent) as a pigment-dispersing agent, the mixture was heated and stirred, and sodium hydroxide corresponding to a neutralization degree of 50% was added thereto to prepare a neutralized product of the pigment-dispersing agent. To the mixed liquid, 30 parts by mass of carbon black was added and premixed, and then dispersed by using a sand grinder filled with 50% by volume of 0.5 mm zirconia beads, thereby obtaining a black pigment dispersion liquid having a pigment concentration of 30% by mass and a solid concentration of 37% by mass. Note that the pigment-dispersing agent used had a weight-average molecular weight of 16000 and an anionic group equivalent weight of 3.5 meq/g.

### 2-2. Water-Dispersible Resin

As dispersion liquids of a water-dispersible resin, the following were prepared: TAKELAC (R) W-6061 (manufactured by DKS Co., Ltd., a dispersion liquid having a solid content concentration of 30% by mass using water as a dispersion medium) and TAKELAC (R) W-6110 (manufactured by DKS Co., Ltd., a dispersion liquid having a solid content concentration of 32% by mass using water as a dispersion medium).

### 2-3. Blocked Isocyanate Compound

Blocked isocyanate compounds 1 to 6 obtained by blocking all isocyanate groups of isocyanate compounds of the following compounds (1) to (5) with respective blocking agents shown in the following Table 1 were prepared.

TABLE 1

| | Isocyanate | |
|---|---|---|
| Blocked isocyanate compound | compound | Blocking agent |
| Blocked isocyanate compound 1 | Compound (1) | 3,5-Dimethylpyrazole |
| Blocked isocyanate compound 2 | Compound (2) | 3,5-Dimethylpyrazole |
| Blocked isocyanate compound 3 | Compound (3) | 3,5-Dimethylpyrazole |
| Blocked isocyanate compound 4 | Compound (3) | Methyl ethyl |
| | | ketone oxime |
| Blocked isocyanate compound 5 | Compound (4) | 3,5-Dimethylpyrazole |
| Blocked isocyanate compound 6 | Compound (5) | 3,5-Dimethylpyrazole |

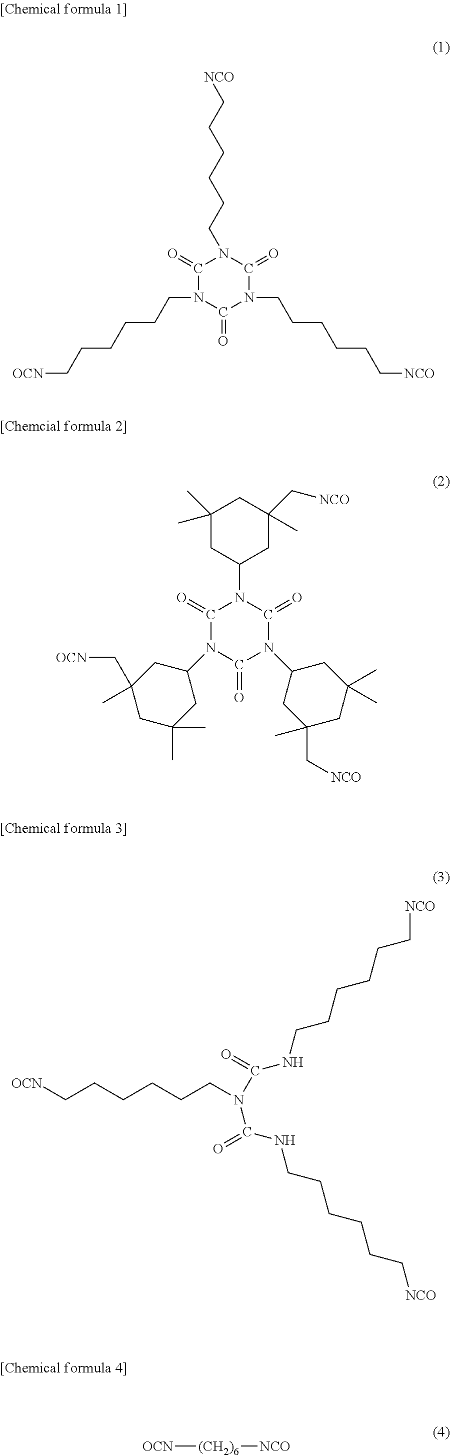

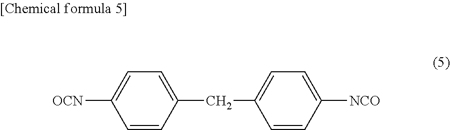

### 2-4. Preparation of Ink

The following components were mixed so that the total amount was 100.00 parts by mass to prepare ink 1. The amounts of the pigment dispersion liquid and the water-dispersible resin dispersion liquid to be added include the amount of volatile matter (solvent).

Composition of Ink 1

| | |
|---|---|
| Pigment dispersion liquid prepared by the | 9.00 parts by mass |
| above method: | |
| TAKELAC (R) W-6061: | 30.00 parts by mass |
| Blocked isocyanate compound 1: | 1.00 parts by mass |
| Glycerin: | 10.00 parts by mass |
| Propylene glycol: | 20.00 parts by mass |
| ProxelGXL (S) (preservative, manufactured | 0.05 parts by mass |
| by Lonza): | |
| Surfynol E1010 (surfactant, manufactured | 0.10 parts by mass |
| by Nissin Chemical Industry Co., Ltd.): | |
| Ion-exchanged water: | balance |

Inks 2 to 13 were prepared in the same manner except that the ink formulation was changed as shown in Table 2.

The compositions of the ink 1 to 13 are listed in Table 2.

TABLE 2

| Composition | | Ink 1 | Ink 2 | Ink 3 | Ink 4 | Ink 5 | Ink 6 | Ink 7 |
|---|---|---|---|---|---|---|---|---|
| Pigment dispersion | Pigment dispersion | 9.00% | 9.00% | 9.00% | 9.00% | 9.00% | 9.00% | 9.00% |
| liquid | liquid | | | | | | | |
| Resin dispersion | TAKELAC W-6061 | 30.00% | 30.00% | 30.00% | 30.00% | 30.00% | 30.00% | 30.00% |
| liquid | TAKELAC W-6110 | | | | | | | |
| Blocked isocyanate | Blocked isocyanate | 1.00% | | | | | | |
| compound | compound 1 | | | | | | | |
| | Blocked isocyanate | | 1.00% | | | | | |
| | compound 2 | | | | | | | |
| | Blocked isocyanate | | | 0.05% | 0.10% | 0.50% | 1.00% | 1.50% |
| | compound 3 | | | | | | | |
| | Blocked isocyanate | | | | | | | |
| | compound 4 | | | | | | | |
| | Blocked isocyanate | | | | | | | |
| | compound 5 | | | | | | | |
| | Blocked isocyanate | | | | | | | |
| | compound 6 | | | | | | | |
| Solvent | Glycerin | 10.00% | 10.00% | 10.00% | 10.00% | 10.00% | 10.00% | 10.00% |
| | Propylene glycol | 20.00% | 20.00% | 20.00% | 20.00% | 20.00% | 20.00% | 20.00% |
| Preservative | Proxcel GXL(S) | 0.05% | 0.05% | 0.05% | 0.05% | 0.05% | 0.05% | 0.05% |
| Active agent | Surfynol E1010 | 0.10% | 0.10% | 0.10% | 0.10% | 0.10% | 0.10% | 0.10% |
| | Ion-exchanged water | 29.85% | 29.85% | 30.80% | 30.75% | 30.35% | 29.85% | 29.35% |
| | Total | 100.00% | 100.00% | 100.00% | 100.00% | 100.00% | 100.00% | 100.00% |

| Composition | | Ink 8 | Ink 9 | Ink 10 | Ink 11 | Ink 12 | Ink 13 |
|---|---|---|---|---|---|---|---|
| Pigment dispersion | Pigment dispersion | 9.00% | 9.00% | 9.00% | 9.00% | 9.00% | 9.00% |
| liquid | liquid | | | | | | |
| Resin dispersion | TAKELAC W-6061 | 30.00% | 30.00% | 30.00% | 30.00% | 30.00% | |
| liquid | TAKELAC W-6110 | | | | | | 31.25% |
| Blocked isocyanate | Blocked isocyanate | | | | | | |
| compound | compound 1 | | | | | | |
| | Blocked isocyanate | | | | | | |
| | compound 2 | | | | | | |
| | Blocked isocyanate | 2.00% | | | | | 1.00% |
| | compound 3 | | | | | | |
| | Blocked isocyanate | | 1.00% | | | | |
| | compound 4 | | | | | | |
| | Blocked isocyanate | | | 1.00% | | | |
| | compound 5 | | | | | | |
| | Blocked isocyanate | | | | 1.00% | | |
| | compound 6 | | | | | | |
| Solvent | Glycerin | 10.00% | 10.00% | 10.00% | 10.00% | 10.00% | 20.00% |
| | Propylene glycol | 20.00% | 20.00% | 20.0096 | 20.00% | 20.00% | 10.00% |
| Preservative | Proxcel GXL(S) | 0.05% | 0.05% | 0.05% | 0.05% | 0.05% | 0.10% |
| Active agent | Surfynol E1010 | 0.10% | 0.10% | 0.10% | 0.10% | 0.10% | 0.05% |
| | Ion-exchanged water | 28.85% | 29.85% | 29.85% | 29.85% | 30.85% | 28.60% |
| | Total | 100.00% | 100.00% | 100.00% | 100.00% | 100.00% | 100.00% |

### 3. Preparation of Post-Treatment Liquid

A post-treatment liquid was prepared in the same manner as in ink 1 except that the blocked isocyanate compound and the pigment dispersion liquid were not added, and the amount of ion-exchanged water added was adjusted such that the total amount was 100.00 parts by mass.

### 4. Image Formation and Evaluation

### 4-1. Image Formation for Initial Evaluation

Using the prepared pre-treatment liquid, inks, and post-treatment liquid, image formation was performed for each ink. At this time, ink that had not been stored over time after preparation was used.

First, a simple printing tester equipped with a KM1024i head manufactured by Konica Minolta, Inc. was prepared as the image forming apparatus. In the head, heads for a pre-treatment liquid, an ink, and a post-treatment liquid are provided adjacent to each other, and the prepared pre-treatment liquid, each ink, and post-treatment liquid were set in the respective heads. Note that the application of the pre-treatment liquid, each ink, and the post-treatment liquid described below was continuously performed such that the landing timing on the base material was in the order of the pre-treatment liquid, the ink, and the post-treatment liquid.

### (1) Application of Pre-Treatment Liquid

As a base material, cotton satin (100% cotton) was prepared. Next, the pre-treatment liquid was discharged from the head onto the base material to apply the pre-treatment liquid to the base material, thereby obtaining a treated base material. The application amount of the treatment liquid was set to 12 g/m².

### (2) Application of Ink

200 mm×200 mm image was formed on the treated base material. The ink ejection was performed in the main scanning 540 dpi×sub-scanning 720 dpi. Note that dpi represents the number of ink droplets (dots) per 2.54 cm. The ejection frequency was set to 22.4 kHz.

### (3) Application of Post-Treatment Liquid

The post-treatment liquid was ejected from the head onto the base material onto which the ink had been applied as described above, thereby applying the post-treatment liquid. Thereafter, drying was peformed at 150° C. for 3 minutes by a belt conveying type dryer to obtain an image-formed product. The application amount of the treatment liquid was set to 12 g/m².

### 4-2. Image Formation for Storage Stability Evaluation

Image formation for storage stability evaluation was performed in the same manner as “4-1. Image formation for initial evaluation” except that the ink that had been stored for 7 days at 50° C. was used.

### 4-3. Evaluation

The wet friction fastness and texture of the obtained image-formed product for initial evaluation and the wet friction fastness of the image-formed product for storage stability evaluation were evaluated by the following methods.

### (1) Wet Friction Fastness

The wet friction fastness of the image-formed product for initial evaluation was evaluated with a crockmeter (rubbing tester type I) in accordance with the JIS L 0849:2013 Wetting Test.

To be specific, a white cotton cloth for rubbing was rubbed back and forth 10 times on the 100 mm×100 mm area of the formed image under the load of a 9 N in the length of the 100 mm. As the white cotton cloth for rubbing, a white cotton cloth wetted with water to be in a wet state of about 100% was used. After the rubbing, color transfer to the white cotton cloth for rubbing was observed, and the wet friction fastness was evaluated according to the following standard (wet friction fastness at the initial stage of storage). In the following standard, 3 or more was regarded as an acceptable range.

The wet friction fastness (wet friction fastness after storage over time) was evaluated in the same manner except that the image-formed product for storage stability evaluation was used instead of the image-formed product for initial evaluation. The wet friction fastness after storage was also evaluated according to the following standard, and 3 to 5 were regarded as an acceptable range.
5: No color transfer is observed
4: Substantially no color transfer is observed
3: Color transfer is observed but is acceptable
2: Color transfer is observed, and is at a level exceeding an acceptable range
1: Significant color transfer is observed

### (2) Texture

The image-formed product for initial evaluation was cut into a size of 5×20 cm to obtain a sample piece. The bending stresses B-MEAN [gf*cm²/cm] of the unused base material and the image forming base material were measured using a KES-FB2-A pure bending tester (manufactured by Kato Tech Co., Ltd.). Then, the difference AB between the bending stresses of the unprocessed base material and the image forming base material was calculated and evaluated based on the following standard.

Note that the width of the base material was 20 cm. Furthermore, an unused base material refers to a base material to which neither an ink nor a treatment liquid has been applied, and a treated image forming base material refers to a base material (image-formed product) to which all of a pre-treatment liquid, an ink, and a post-treatment liquid have been applied. Note that 3 to 5 were determined to be within an acceptable range.
5: The AB is 0.06 or less
4: The AB is more than 0.06 and 0.09 or less
3: The AB is more than 0.09 and 0.12 or less
2: The AB is more than 0.12 and 0.15 or less
1: The AB is more than 0.15

### (3) Results

Table 3 shows the evaluation results of the image-formed products of examples 1 to 9 and comparative examples 1 to 4 corresponding to the respective inks 1 to 13.

TABLE 3

| | | Wet friction fastness | | |
|---|---|---|---|---|
| | | | Storage | |
| Image-formed | | Initial | stability | |
| product No. | Ink No | evaluation | evaluation | Texture |
| Example 1 | Ink 1 | 5 | 5 | 4 |
| Example 2 | Ink 2 | 5 | 5 | 3 |
| Example 3 | Ink 3 | 3 | 3 | 5 |
| Example 4 | Ink 4 | 3 | 3 | 5 |
| Example 5 | Ink 5 | 4 | 4 | 5 |
| Example 6 | Ink 6 | 5 | 5 | 5 |
| Example 7 | Ink 7 | 5 | 5 | 4 |
| Example 8 | Ink 8 | 5 | 5 | 3 |
| Example 9 | Ink 13 | 5 | 5 | 3 |
| Comparative example 1 | Ink 9 | 3 | 1 | 5 |
| Comparative example 2 | Ink 10 | 2 | 1 | 5 |
| Comparative Example 3 | Ink 11 | 2 | 1 | 1 |
| Comparative example 4 | Ink 12 | 1 | 1 | 5 |

As illustrated in Table 3, it is found that the image-formed products of examples 1 to 9 using the blocked isocyanate compounds including three or more blocked isocyanate groups in which an isocyanate group is blocked with dimethylpyrazole can increase the friction fastness even when the inks are stored over time.

In addition, when Example 6 using a blocked isocyanate compound having no cyclic structure is compared with Example 1 and 2, it is found that the fewer cyclic structures contained in a blocked isocyanate compound, the better the texture. In particular, it is found that example 6 using the blocked isocyanate compound having no cyclic structure is particularly excellent in texture.

### INDUSTRIAL APPLICABILITY

According to the present invention, an inkjet ink can be provided that can increase the friction fastness even when the ink is stored over time.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet ink, comprising:
water, a water-dispersible resin, and a blocked isocyanate compound, wherein
the blocked isocyanate compound includes three or more blocked isocyanate groups blocked with dimethylpyrazole.

2. The inkjet ink according to claim 1, wherein
the blocked isocyanate compound does not have a cyclic structure.

3. The inkjet ink according to claim 1, wherein
the blocked isocyanate compound is a compound in which isocyanate groups of hexamethylene diisocyanate biuret is blocked.

4. The inkjet ink according to claim 1, wherein
the water-dispersible resin is an ether-based urethane resin.

5. The inkjet ink according to claim 1, wherein
a content of the blocked isocyanate compound is 0.10% by mass to 1.00% by mass with respect to a total mass of the inkjet ink.

6. The inkjet ink according to claim 1, wherein
the inkjet ink is for textile printing.

7. An image forming method, comprising:
applying the inkjet ink according to claim 1 onto a base material by an inkjet method.
